(19) United States
(12) Patent Application Publication
(10) Pub. No.: US 2006/0013120 A1
(43) Pub. Date: Jan. 19, 2006

(54) Method and apparatus for providing local channels in a global satellite/terrestrial network

(76) Inventor: Hong Jiang, Warren, NJ (US)

Correspondence Address: BROSEMER, KOLEFAS & ASSOCIATES, LLC - (LUCENT), 1 BETHANY ROAD, BUILDING 4 - SUITE # 58, HAZLET, NJ, 07730, US

(21) Appl. No.: 10/892,834

(22) Filed: Jul. 16, 2004

(51) Int. Cl. H04J 11/00

(52) U.S. Cl. 370/207

(57) ABSTRACT

In a transmission system that employs terrestrial repeaters to supply signals to mobile receivers, an auxiliary channel is added in addition to a primary channel, at the terrestrial repeaters to transmit data of a local nature. The auxiliary channel can carry local data, which could be different at each terrestrial repeater and, hence at each different metropolitan area. The primary channel carries the data transmitted in the global network or other wide area network. In this manner pre-existing receivers in use prior to the addition of the auxiliary channel can still receive the global data. Another advantage is that a user only needs to tune to the auxiliary channel, and as the mobile receiver moves from one metropolitan area to another the data content of the auxiliary channel is automatically changed to that of the new metropolitan area. This is realized by adding the auxiliary channel at each desired terrestrial repeater. The primary channel including the global data content is supplied to the repeater in any desired manner, for example, a satellite network or some other terrestrial network. Before the global data content is re-transmitted the local data content intended for this metropolitan area only is added via the auxiliary channel for transmission. Then, the combined global and local data content is re-transmitted by the repeater.

### RELATED APPLICATION

U.S. patent application Ser. No. (H. Jiang 17) was filed concurrently herewith.

### TECHNICAL FIELD

This invention relates to communication systems and, more particularly, to transmitting auxiliary channels in an existing transmission system.

### BACKGROUND OF THE INVENTION

Known digital transmission systems, for example digital satellite radio, use satellites to transmit signals to mobile receivers. In some reception areas, for example metropolitan areas, signals from the satellite may be weakened because of blockage caused by tall buildings, other obstructions and the like. It has become common place to deploy terrestrial repeaters in such metropolitan areas where it is difficult to receive an adequate satellite signal. The terrestrial repeaters transmit the same data content as is transmitted through the satellite, except they may possibly employ a different modulation format.

In such a system, because all receivers receive the same data content broadcast through the satellite, or the terrestrial repeaters, it is difficult to provide local channels including data that is of interest only to users in a particular locale. Examples of such channels are local weather, local traffic conditions, local advertisements and the like.

Presently, in such satellite systems or other wide area transmission systems, the local channels are carried in the entire “global” network and broadcast to all receivers. A receiver receives all the channels and a user selects the channels of interest to him/her. There are reasons why such use of a satellite system is undesirable. For example, it does not provide an optimal use of bandwidth. Information of interest to other metropolitan areas is carried to every metropolitan area. Additionally, the user has to manually tune a desired local channel. In such a system, it would be difficult to implement an automatic tuning arrangement that could automatically tune to a new local channel as the mobile unit moves from one metropolitan area to another.

### SUMMARY OF THE INVENTION

These and other problems and limitations of the prior known transmission systems that employ terrestrial repeaters to supply signals to mobile receivers, by transmitting an auxiliary channel, in addition to a primary channel, at terrestrial repeaters.

The auxiliary channel can carry local data, which could be different at each terrestrial repeater and, hence at each different metropolitan area. The primary channel carries the data transmitted in the global network or other wide area network. In this manner pre-existing receivers in use prior to the addition of the auxiliary channel can still receive the global data. Another advantage is that a user only needs to tune to the auxiliary channel, and as the mobile receiver moves from one metropolitan area to another the data content of the auxiliary channel is automatically changed to that of the new metropolitan area.

This is realized by adding the auxiliary channel at each desired terrestrial repeater. The primary channel including the global data content is supplied to the repeater in any desired manner, for example, a satellite network or some other terrestrial network. Before the global data content is re-transmitted the local data content intended for this metropolitan area only is added via the auxiliary channel for transmission. Then, the combined global and local data content is re-transmitted by the repeater.

This is realized, in one embodiment of the invention, for example, in a quadrature phase shift keying (QPSK) transmission system, by utilizing a “large” phase variation component to modulate the primary channel and a relatively “small” amplitude variation component to modulate the new auxiliary channel.

There are a number of known transmission schemes in which applicant's unique auxiliary channel modulation scheme can be used to realize his unique invention. One example of such a transmission system is the Direct Sequence Spread Spectrum Code Division Multiple Access (DS-CDMA) transmission system. In any such scheme the amplitude modulation, denoted by “+/−a”, the value of parameter “a” can be adjusted to adjust the data rate of the auxiliary channel. In general, the larger parameter “a” is, the higher the data rate of the auxiliary channel.

Such terrestrial repeaters may also find application outside highly populated metropolitan areas, especially in areas where there are other tall structures and obstructions.

### BRIEF DESCRIPTION OF THE DRAWING

FIG. 1 shows, in simplified block diagram form, details of a prior known QPSK modulator;

FIG. 2 graphically illustrates a constellation generated by the prior known QPSK modulator shown in FIG. 1;

FIG. 3 shows, in simplified block diagram form, details of an enhanced QPSK modulator in accordance with the invention;

FIG. 4 graphically illustrates a constellation generated by an embodiment of the enhanced QPSK modulator shown in FIG. 3;

FIG. 5 depicts, in simplified block diagram form, an enhanced QPSK transmission system embodying an embodiment of the invention;

FIG. 6 shows, in simplified block diagram form, details of an enhanced QPSK receiver used in the system of FIG. 5;

FIG. 7 illustrates, in simplified form, a prior known transmission scheme including a plurality of metropolitan areas; and

FIG. 8 shows, in simplified form, a transmission scheme including a plurality of metropolitan areas each including an embodiment of the invention.

### DETAILED DESCRIPTION

FIG. 1 shows, in simplified block diagram form, details of a prior known QPSK modulator 100. Specifically, shown are bits to QPSK Mapping Unit 101 and Modulation Unit 102.

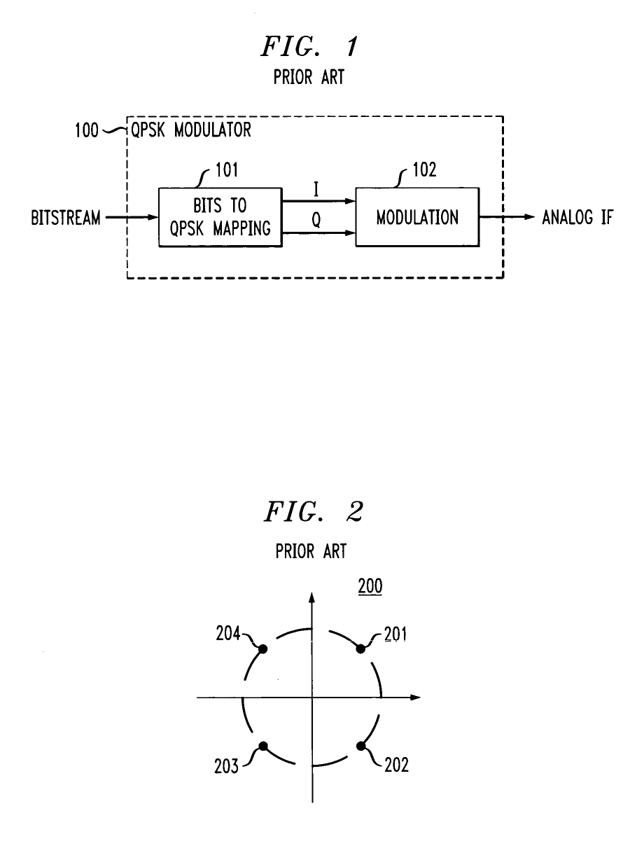

In QPSK modulation, a cosine carrier is typically varied in phase while maintaining a constant amplitude and frequency. The term “quadrature” implies that there are four possible phases (4-PSK), which the carrier can have at a given time, as shown in FIG. 2 on the characteristic constellation. The four phases are labeled 201, 204, 203 and 202 corresponding to one of 45, 135, 225 and 315 degrees, respectively.

In QPSK, information is conveyed through phase variations. This is realized in Bits to QPSK Mapping Unit 101 where the input digital bitstream is mapped into the in-phase (I) and quadrature-phase (Q) components of the QPSK signal (the primary QPSK channel). The I component is the real part and the Q component is the imaginary part of the QPSK symbols. Specifically, in each time period, the phase can change once. Since there are four possible phases, there are 2 bits of information conveyed within each time slot. That is, a pair of input data bits is mapped via Bits to QPSK Mapping Unit 101 into the I and Q components. The rate of change (baud) in this signal determines the signal bandwidth, but the throughput or bit rate for QPSK is twice the baud rate.

The I and Q components are supplied to Modulation Unit 102 where they are modulated into a particular scheme for transmission. The modulator typically takes the I and Q components, performs a pulse shaping filtering on the I and Q component signals, and then converts the resulting digital signals to either an analog intermediate frequency (IF) signal, or an analog baseband signal.

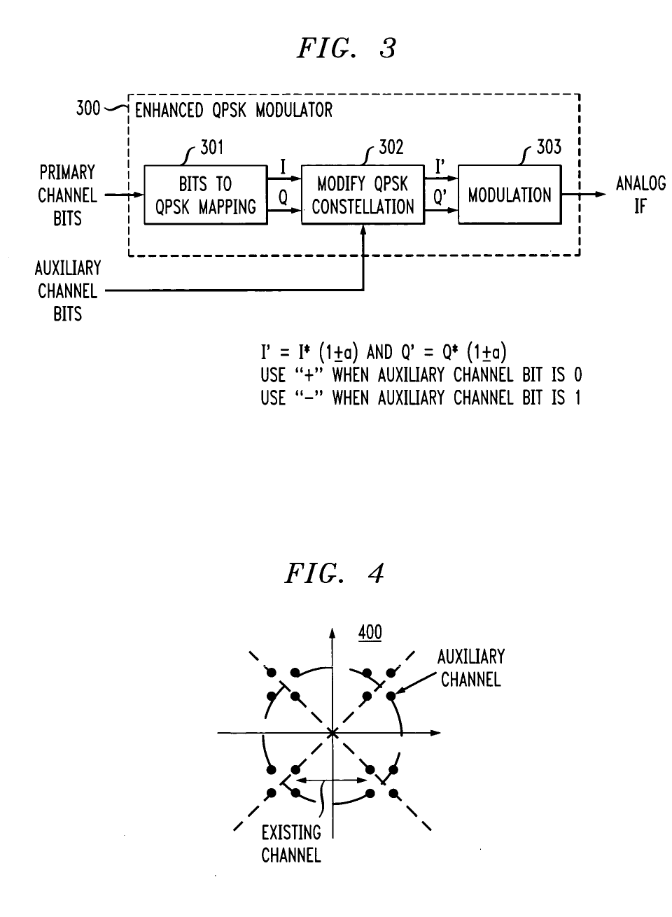

FIG. 3 shows, in simplified block diagram form, details of an Enhanced QPSK Modulator 300, in accordance with the invention. Specifically, shown are Bits to QPSK Mapping Unit 301, Modify QPSK Constellation Unit 302 and Modulation Unit 303. Here, the primary channel input bit stream is supplied to Bits to Mapping Unit 301, which operates in identical fashion as Bits to QPSK Mapping Unit 101 of FIG. 1 to generate the primary channel I and Q components. These primary channel I and Q components are supplied to Modify QPSK Constellation Unit 302 along with the auxiliary channel input bits.

Operation of Modify QPSK Constellation Unit 302 is to generate the enhanced QPSK constellation, an example of which is shown as constellation 400 of FIG. 4. This is realized, in accordance with the invention, by Modify QPSK Constellation Unit 302 generating the enhanced QPSK symbols including components I′ and Q′.

As indicated above, the primary channel, or the original transmission system, uses PQSK where every two bits of data is mapped to a symbol I+j Q, where j is the imaginary unity. In the enhanced QPSK transmission system, every two bits from the primary channel data, and every two bits from the auxiliary channel data are mapped to the symbol I (1+/−a)+j Q (1+/−a). The mapping between the two bits from the primary channel data and I, Q is the same as in the prior QPSK system. However, in the enhanced QPSK system, the auxiliary channel data is carried in the system by the variation +/−a. The sign “+/−” depends on the polarity of the auxiliary channel bits. The amplitude “a” can be adjusted to adjust the data rate of the auxiliary channel and the interference to the primary channel.

In a receiver that is deployed before the enhanced QPSK system is introduced, the amplitude variation +/−a represents a small noise in the transmission system. Such a receiver will demodulate the primary channel only, regarding I(1+/−a)+j Q(1+/−a) as simply I+j Q. New receivers can be built to receive both the primary and the auxiliary channel data. Such new receivers will extract both I, Q for the primary channel, and +/−a for the auxiliary channel.

In one specific embodiment, I′ and Q′ are generated for each primary channel symbol (I, Q) by taking two (2) auxiliary channel input bits, for example, b1 and b2, to form in conjunction with the I and Q components from the primary channel the enchanted QPSK symbol components I′ and Q′ as follows:
If b1=0, then I′=I(1+a), and if b1=1, then I′=I(1−a);
If b2=0, then Q′=Q(1+a), and if b2=1, then Q′=Q(1−a),
where b1 and b2 are logical 1 or logical 0.

It is noted that this is but one example of an embodiment of the invention. It is further noted the parameter “a” is typically less than one (1), and in one specific example “a” is 0.1. There are a number of arrangements in which the auxiliary channel can be modulated by +/−a. One example of such a system, is the Direct Sequence Spread Spectrum Code Division Multiplex Access (DS-CDMA) system. In such a system, the value of parameter “a” can be adjusted to control the data rate of the auxiliary channel. In general, the larger the value of parameter “a” is, the higher the data rate of the auxiliary channel.

Thus, as indicated above, the primary channel QPSK components I and Q are obtained by utilizing a “large” phase variation component to modulate the primary channel and, then, the enhanced QPSK components I′ and Q′ are realized by utilizing a relatively “small” amplitude variation component to modify the QPSK components I and Q in Modify QPSK Constellation Unit 302 to obtain the new auxiliary channel in the enhanced QPSK channel including components I′ and Q′. Modulation Unit 303, operates in identical fashion as Modulation Unit 102 of FIG. 1, to convert the digital signals to either an analog IF output signal, or analog baseband output signal.

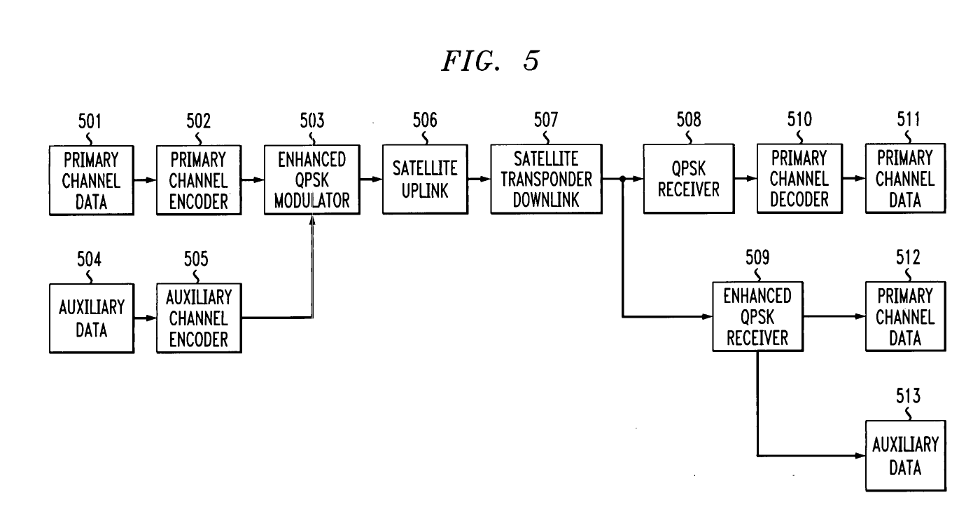

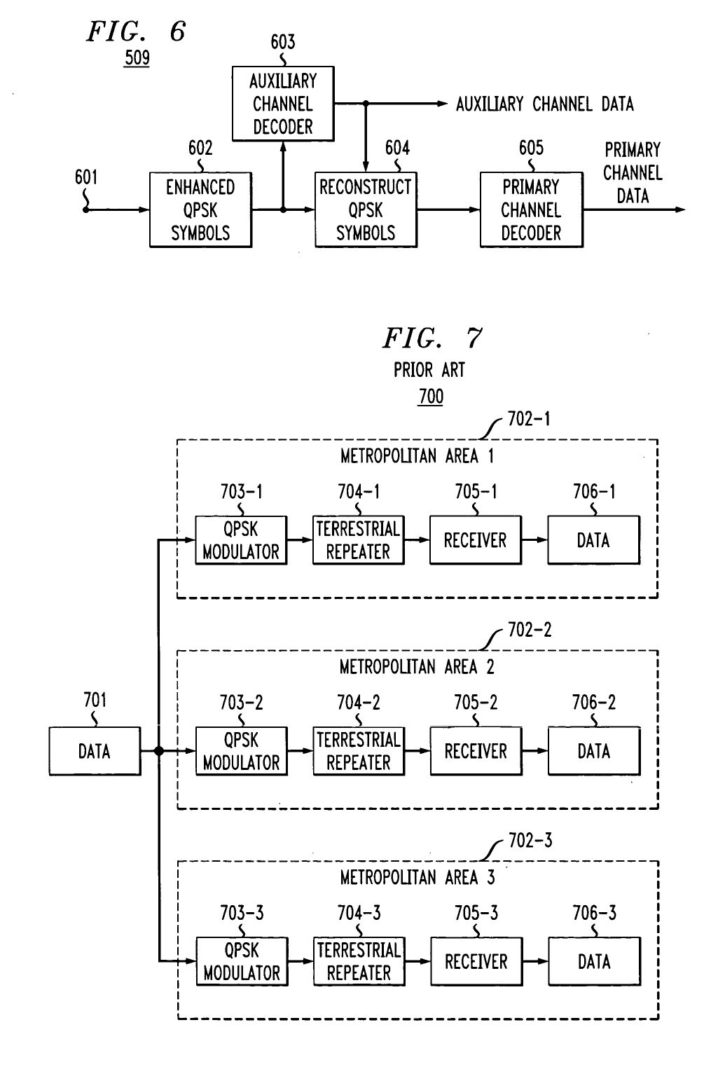

In the enhanced QPSK modulation scheme of FIG. 3, the auxiliary channel acts as relative small white noise components to the primary channel. Consequently, it is possible to continue using existing receivers to receive at least the primary channel in the enhanced QPSK system without need for any modification. However, the auxiliary channel, acting as white noise, does impose a small penalty in the performance of the existing receivers. This penalty depends of the value of parameter “a”. The larger parameter “a” is, the larger the penalty is. However, a new enhanced QPSK receiver 509 of FIG. 5 and shown in FIG. 6, to be described below, for the enhanced QPSK system, is readily designed to avoid any such penalty. That is, the new enhanced QPSK receiver 509 is designed such that its performance in receiving the primary channel is as good as the receivers in the prior QPSK system before the auxiliary channel was added.

It is estimated that by employing, for example, the DS-CDMA scheme for the auxiliary channel, parameter “a” is approximately 10% of the amplitude of the primary channel symbols, then the penalty to the prior existing receivers is approximately 0.2 dB under most operating conditions, while the data rate of the auxiliary channel is approximately 1% of that of the primary channel, with the same error rate as the primary channel.

Again, parameter “a” is a system parameter that controls the amount of penalty to the prior existing QPSK receivers, and the data rate of the auxiliary channel in the enhanced QPSK system. Thus, initially the value of parameter “a” for the enhanced QPSK system can be chosen to be relatively small, for example, the 0.1 value noted above, so that only a relatively small penalty results in the prior existing receivers. As these prior existing QPSK receivers are gradually phased out of service, the value of parameter “a” can be increased to increase the bit rate of the auxiliary channel.

FIG. 4 graphically illustrates a constellation generated by an embodiment of the enhanced QPSK modulator shown in FIG. 3. As shown, the auxiliary channel modulation results in the constellation points about the primary channel modulation at each of the vectors at 45°, 135°, 225° and 315°. When the auxiliary channel is added, there are the following possibilities:
Using the first quadrant as an example: the symbol is I+j Q, where I=1, Q=1.

The conventional QPSK is one point at (1,1) in the first quadrant.

Then the:
real part is: 1+a, 1−a, imaginary part is: 1+a, 1−a, depending on the polarity of the auxiliary channel bits b1 and b2, as indicated above.
This creates four possible positions at each vector:
(I+a, 1+a), (1+a, 1−a), (1−a, 1+a) and (1−a, 1−a).

These are the four points on the first quadrant vector of the constellation of FIG. 4.

FIG. 5 depicts, in simplified block diagram form, an enhanced QPSK transmission system embodying an embodiment of the invention. Specifically shown is primary channel data source 501 that supplies, digital or otherwise, to primary channel encoder 502. Primary channel encoder 502 encodes the incoming primary channel data into a particular format as desired. In one example, the primary channel format is convolutional encoding. Thereafter, the encoded primary bit stream is supplied as an input to enhanced QPSK modulator 503. Similarly, incoming auxiliary channel data is supplied from auxiliary data source 504 to auxiliary channel encoder 505. Auxiliary channel encoder 505 encodes the incoming auxiliary channel data into a particular format as desired. In one example, the auxiliary channel format is Direct Sequence Spread Spectrum Code Division Multiplex Access (DS-CDMA). Thereafter, the encoded primary bit stream is supplied as a second input to enhanced QPSK modulator 503. As described above, enhanced QPSK modulator 503 generates a modulated output signal, for example, an analog intermediate frequency signal, which is supplied, in this example, to satellite uplink unit 506. Satellite uplink unit 506, in response to the supplied IF signal, typically generates a high frequency transmission signal, in known fashion, to carry the enhanced QPSK modulated data to a remote location, in this example, a satellite. In the satellite, the transmission signal is received and supplied to a satellite transponder where it is prepared for transmission to one or more earth stations, again in well known fashion. The earth stations could be either fixed or mobile. At an earth station there could be a prior existing QPSK receiver 508 or a new enchanted QPSK receiver 509. Details of new enchanted QPSK receiver 509 are shown in FIG. 6 and described below. QPSK receiver 508 demodulates the incoming signal and supplies the demodulated bit stream to primary channel decoder 510. The demodulation in QPSK receiver 508 is the inverse of the primary channel modulation effected in enhanced QPSK modulator 503 on the transmitter side. Similarly, primary channel decoder 510 effects the decoding of the bit stream in accordance with the inverse of the encoding format used in the primary channel encoder 502. The decoded data signal is supplied to the prior known primary channel data unit 511. Also on the receive side, new enhanced QPSK receivers 509 are also deployed. Enhanced QPSK receiver 509 effect the demodulation of both the primary channel modulated signal and the auxiliary channel modulated signal. The demodulated primary channel data is supplied to primary channel data unit 512, while the demodulated auxiliary channel data is supplied to auxiliary data unit 513. The primary channel and auxiliary channel data units output the primary and auxiliary data in desired form as desired by a user of the enhanced QPSK receiver.

FIG. 6 shows, in simplified block diagram form, details of enhanced QPSK receiver 509. The received incoming signals are supplied from input terminal 601 to received enhanced symbols unit 602, which extracts the enhanced symbols from the incoming signal, in known fashion. This process usually involves a digital filter, timing recovery, carrier recovery and equalization. The recovered enhanced QPSK symbols are used in auxiliary channel decoding unit 603, which extracts the auxiliary channel data. In unit 603, the amplitude variation +/−a of the enhanced QPSK symbols I (1+/−a)+j Q (1+/−a) is detected in conjunction with the channel encoding, such as DS-CDMA. The detected amplitude variation +/−a is used to decode the auxiliary channel data.

The primary channel data can be extracted from the enhanced QPSK symbols by ignoring the amplitude variation +/−a. The existing receivers that are deployed before the enhanced QPSK system is introduced can receive the primary channel data in this fashion. However, in new receivers, the reception performance of the primary channel can be improved by the reconstruct QPSK symbols unit 604. Since the amplitude variation, +/−a, is detected in unit 603, it can be subtracted from the enhanced QPSK symbols I(1+/−a)+j Q(1+/−a) to reconstruct the QPSK symbols I+j Q. The reconstructed QPSK symbols are used in the primary channel decoding unit 605 where the QPSK symbols are decoded into the primary channel using a QPSK decoder in a well known standard fashion.

FIG. 7 illustrates, in simplified form, a prior known global or other wide area transmission network 700 including a plurality of metropolitan areas 702-1 through 702-3, by way of an example. Data is supplied from data source 701 via satellite radio or some wide area terrestrial network to each of the metropolitan areas 702. Metropolitan area 702 equipment is essentially identical in all of area 702-1 through 702-3. Therefore, only the equipment in metropolitan area 702-1 will be described in detail. Specifically shown are QPSK modulator 703-1, terrestrial repeater 704-1, receiver 705-1 and data unit 706-1. QPSK modulator 703-1 is essentially identical to the QPSK modulator shown in FIG. 1 and described above. The prior art modulated primary channel information is supplied to terrestrial repeater 704-1 where it is broad cast to mobile receivers 705-1 in this metropolitan area 702-1. Such terrestrial repeaters are known in the art. The transmitted primary channel is received by receivers 705-1, in this metropolitan area 702-1, where it is demodulated and decoded to obtain the originally transmitted data. The received data in outputted via data unit 706-1.

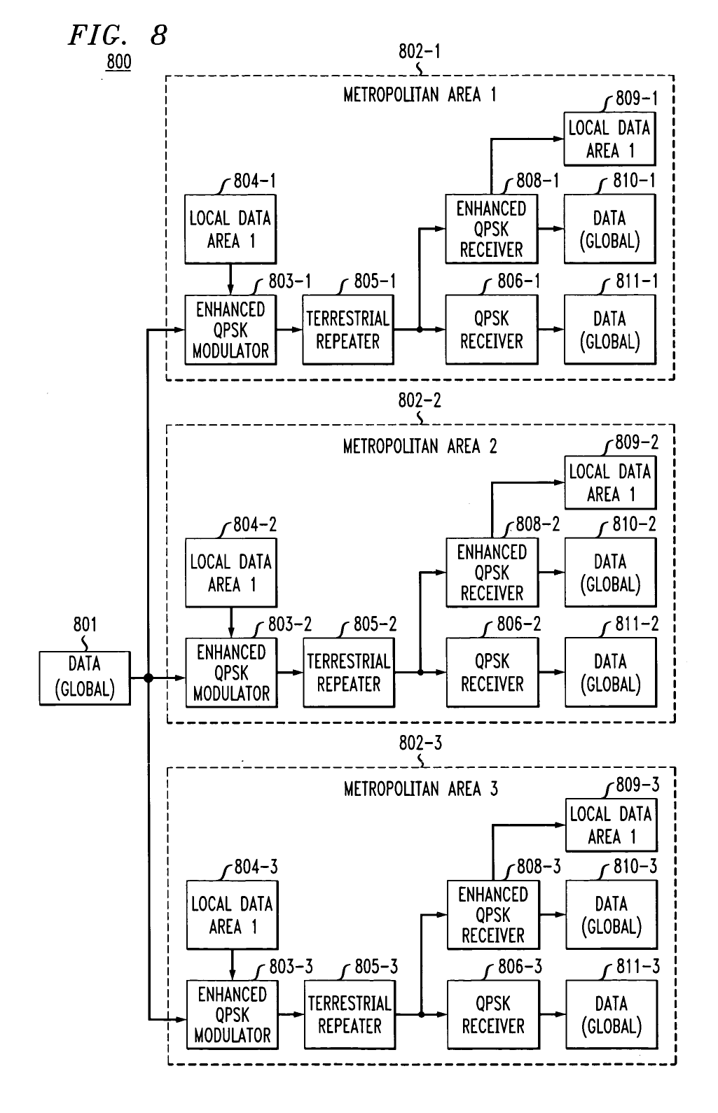

FIG. 8 shows, in simplified form, a global transmission network or some other wide area transmission network 802-1 including, in this example, a plurality of metropolitan areas 802-1, 802-2 and 802-3 each including an embodiment of the invention. The only differences in the equipment used in the metropolitan areas is the local data inserted. Specifically, local data unit 804-1 inserts local data (local data area 1) for metropolitan area 802-1, local data unit 804-2 inserts local data (local data area 2) for metropolitan area 802-2, and local data unit 804-3 inserts local data (local data area 3) for metropolitan area 802-3. On the receive side, the local data for area 1 is supplied to local data unit 809-1, the local data for area 2 is supplied to local data unit 809-2, and the local data for area 3 is supplied to local data unit 809-3. Therefore, the equipment in metropolitan area 802-1 only will be described in detail.

Specifically, the global data, i.e., the primary channel data, is supplied from data source 801 via satellite radio or some wide area terrestrial network to each of the metropolitan areas 802. The primary channel data from data unit 801 is typically supplied via an encoder (not shown here) to enhanced QPSK modulator 803-1. Similarly, the local data for area one is supplied from local data unit 804-1 typically via an encoder (not shown here) to enhanced QPSK modulator 803-1. Enhanced modulator 803-1 is essentially identical to enhanced QPSK modulator 300 shown in FIG. 3 and explained above, and will not be explained again in detail. The enhanced I′ and Q′ symbols are modulated to a desired intermediate frequency analog signal, in this example, in enhanced QPSK modulator 803-1 and supplied as an input to terrestrial repeater 805-1. Such terrestrial repeaters are known in the art and are being deployed in several satellite radio systems. Terrestrial repeater 805-1 transmits the enhanced QPSK signal in usual fashion, and it is received by new enhanced QPSK receiver 808-1 and/or the prior known QPSK receiver 806-1. QPSK receiver 806-1 is a known receiver used in the prior existing transmission system and recives the primary channel data in known fashion. The decoded primary channel data is supplied from QPSK receiver 806-1 to data (global) unit 811-1. A user would tune to a desired channel to receive data as desired in usual fashion.

Enhanced QPSK received 808-1 is essentially identical to enhanced QPSK receiver 509 shown in FIG. 6 and described above. It will not be described again here in detail. The decoded auxiliary channel symbols are supplied from enhanced QPSK receiver 808-1 to local data area 1 unit 809-1, while the decoded primary channel symbols are supplied to data (global) unit 810-11. Here all a user has to do is tune to the auxiliary channel to receive the local data in any of the metropolitan areas 802. The user would receive the primary channel data in the usual fashion as was done in the prior existing transmission system.

Although this embodiment of the invention has been described in terms of QPSK, it will apparent to those skilled in the art that it is equally applicable to other modulation schemes. Examples of such modulation schemes are quadrature amplitude modulation (QAM), 16-phase shift keying (16-PSK) and the like.

What is claimed is:

1. Apparatus for use in a communications transmission system for adding auxiliary channel data at least one terrestrial repeater intended to transmit communications data in a local area, said apparatus comprising:
a mapper for mapping primary channel data bits into first symbols in a constellation of a predetermined first modulation scheme;
a modification unit supplied with said primary channel symbols and auxiliary channel data bits for modifying said first symbols in said constellation in accordance with a predetermined second modulation scheme to generate enhanced symbols in said constellation,
wherein both said primary channel data and said auxiliary channel data are included in said enhanced symbols in said constellation; and
a modulator supplied with said enhanced symbols for modulating them into a modulated signal in a predetermined transmission format,
said modulated signal being supplied to said terrestrial repeater for transmission in said local area.

2. The apparatus as defined in claim 1 wherein said mapper maps every two bits of said primary channel data into symbols of the type I+jQ, where I is the magnitude of the real part, Q is the magnitude of the imaginary part and j represents the imaginary quantity.

3. The apparatus as defined in claim 2 wherein said modification unit generates said enhanced symbols in response to said I and Q values from said mapper and in accordance with the logical state of said auxiliary channel data bits.

4. The apparatus as defined in claim 3 wherein said enhanced symbols are generated in accordance with I′=I(1+a) and Q′=Q(1+a) when said auxiliary channel data bit is a first logical value, and I′=(1−a) and Q′(1−a) when said auxiliary channel data bit is a second logical value, where I′ is the real part and Q′ is the imaginary part of the enhanced symbol, and “a” is a parameter representing the magnitude of the modulation due to the auxiliary channel data bits.

5. The apparatus as defined in claim 4 wherein said parameter “a” is adjustable.

6. The apparatus as defined in claim 4 wherein said parameter “a” is a predetermined percentage of the magnitude of the primary channel symbol magnitude.

7. The apparatus as defined in claim 6 wherein said percentage is approximately 10 percent.

8. The apparatus as defined in claim 1 where said first modulation scheme is quadrature frequency shift keying (QPSK).

9. The apparatus as defined in claim 1 where said second modulation scheme is amplitude modulation.

10. The apparatus as defined in claim 1 further including a first encoder for encoding said primary channel data bits and a second encoder for encoding said auxiliary channel data bits.

11. The apparatus as defined in claim 10 wherein said first encoder is a convolution encoder and said second encoder is a Direct Sequence Spread Spectrum Code Division Multiplex Access (DS-CDMA) encoder.

12. A method for use in a communications transmission system for adding auxiliary channel data at least one terrestrial repeater intended to transmit communications data in a local area, the method comprising the steps of:
mapping primary channel data bits into first symbols in a constellation of a predetermined first modulation scheme; and
in response to said primary channel symbols and auxiliary channel data bits, modifying said first symbols in said constellation in accordance with a predetermined second modulation scheme to generate enhanced symbols in said constellation,
wherein both said primary channel data and said auxiliary channel data are included in said enhanced symbols in said constellation;
modulating said enhanced symbols into a modulated signal in a predetermined transmission format; and
supplying said modulated signal to said terrestrial repeater for transmission in said local area.

13. The method as defined in claim 12 wherein said mapping step maps every two bits of said primary channel data into symbols of the type I+jQ, where I is the magnitude of the real part, Q is the magnitude of the imaginary part and j represents the imaginary quantity.

14. The method as defined in claim 13 wherein said modifying step includes a step of generating said enhanced symbols in response to said I and Q values and in accordance with the logical state of said auxiliary channel data bits.

15. The method as defined in claim 12 wherein said first modulation scheme is quadrature phase shift keying (QPSK).

16. The method as defined in claim 12 wherein said second modulation scheme is amplitude modulation.

17. Apparatus for use in a communications transmission system for adding auxiliary channel data comprising:
a plurality of terrestrial repeaters, each of said terrestrial repeaters being supplied primary channel data from a wide area communications system and being located to re-transmit said primary channel data in a predetermined local are separate from the others of said terrestrial repeaters;
auxiliary channel apparatus located at each of said plurality of terrestrial repeaters for adding local data in an auxiliary channel at an associated terrestrial repeater, each of said auxiliary channel apparatus including,
a mapper for mapping primary channel data bits into first symbols in a constellation of a predetermined first modulation scheme;
a modification unit supplied with said primary channel symbols and auxiliary channel data bits for modifying said first symbols in said constellation in accordance with a predetermined second modulation scheme to generate enhanced symbols in said constellation,
wherein both said primary channel data and said auxiliary channel data are included in said enhanced symbols in said constellation; and
a modulator supplied with said enhanced symbols for modulating them into a modulated signal in a predetermined transmission format,
said modulated signal being supplied to said associated terrestrial repeater for transmission in said local area.

18. The apparatus as defined in claim 17 wherein said mapper maps every two bits of said primary channel data into symbols of the type I+jQ, where I is the magnitude of the real part, Q is the magnitude of the imaginary part and j represents the imaginary quantity, and said modification unit generates said enhanced symbols in response to said I and Q values from said mapper and in accordance with the logical state of said auxiliary channel data bits.

19. A method for use in a communications transmission system for adding auxiliary channel data comprising the steps of:
supplying primary channel data from a wide area communications system to a plurality of terrestrial repeaters, each of said terrestrial repeaters being located to re-transmit said primary channel data in a predetermined local separate from the others of said terrestrial repeaters;
adding separate local data in an auxiliary channel at each of said plurality of terrestrial repeaters by,
mapping primary channel data bits into first symbols in a constellation of a predetermined first modulation scheme;
modifying said first symbols in said constellation in response to auxiliary channel data bits in accordance with a predetermined second modulation scheme to generate enhanced symbols in said constellation,
wherein both said primary channel data and said auxiliary channel data are included in said enhanced symbols in said constellation;
modulating said enhanced symbols into a modulated signal in a predetermined transmission format; and
supplying said modulated signal to an associated one of said plurality of terrestrial repeater for transmission in an associated local area.

20. The method as defined in claim 19 wherein said step of mapping maps every two bits of said primary channel data into symbols of the type I+jQ, where I is the magnitude of the real part, Q is the magnitude of the imaginary part and j represents the imaginary quantity, and said step of modifying generates said enhanced symbols in response to said I and Q values and in accordance with the logical state of said auxiliary channel data bits.
